(19) United States
(12) Patent Application Publication
(10) Pub. No.: US 2013/0101091 A1
(43) Pub. Date: Apr. 25, 2013

(54) Sealed Detector Array for the Collection of Both Wide Angle and Small Angle X-Ray Scattering

(71) Applicants: Hugh F. Garvey, Tucson, AZ (US); Michael A. Damento, Tucson, AZ (US)

(72) Inventors: Hugh F. Garvey, Tucson, AZ (US); Michael A. Damento, Tucson, AZ (US)

(73) Assignee: Rigaku Innovative Technologies, Inc., Auburn Hills, MI (US)

(21) Appl. No.: 13/587,410

(22) Filed: Aug. 16, 2012

Related U.S. Application Data
(60) Provisional application No. 61/524,634, filed on Aug. 17, 2011.

(51) Int. Cl. G01N 23/201

(52) U.S. Cl. CPC G01N 23/201
USPC 378/87; 378/86

(57) ABSTRACT

A detector system for capturing and resolving WAXS and SAXS beams is provided along with a device for determining structural information of a material incorporating said detector system and a method for examining the structure of a material using said detector system. The detector system generally comprises a sample capable of interacting with the incident x-ray beam, a primary detector and a secondary detector. Upon interaction with a sample of the material, the incident x-ray beam is scattered into wide angle x-ray scattering (WAXS) beams and small angle x-ray scattering (SAXS) beams that are captured by the primary or secondary detectors.

This application claims the benefit of U.S. Provisional Application Ser. No. 61/524,634 filed on Aug. 17, 2011, entitled “SEALED DETECTOR ARRAY FOR THE COLLECTION OF BOTH WIDE ANGLE AND SMALL ANGLE X-RAY SCATTERING” the entire contents of which are incorporated herein by reference.

### FIELD

This disclosure relates generally to a system capable of capturing and resolving scattered x-ray data. More particularly, the system is capable of capturing and resolving both wide angle x-ray scattering (WAXS) and small angle x-ray scattering (SAXS).

### BACKGROUND

The statements in this section merely provide background information related to the present disclosure and may not constitute prior art.

X-ray diffraction is an established analytical technique in which an x-ray beam is caused to interact with a sample such that the x-rays become diffracted or scattered. The subsequent measurement of the scattered x-rays provides structural information about the sample. In this technique, the diffraction angle is related to the length scale probed by the measurements with larger length scales corresponding to smaller scattering angles.

Wide angle x-ray scattering (WAXS) systems and small angle x-ray scattering (SAXS) systems represent two related subsets of x-ray diffraction systems that measure the scattered x-rays at different angles in order to obtain complimentary information regarding the probed sample. WAXS is an x-ray-diffraction technique that analyzes x-rays scattered at wide angles (e.g., several degrees up to 180°), while SAXS analyzes x-rays scattered at relatively small angles (e.g., less than about 2-3°. Thus WAXS deals with long-range periodicity within the sample and in the scattering of x-rays caused by subnanometer-sized structures (<1 nm). WAXS systems are often used to determine the crystal structure of the sample on the atomic length scale.

On the other hand, SAXS probes the structure of the sample on a slightly larger length scale, e.g., on the order of approximately 1 to 100 nanometers. Thus SAXS allows for the characterization of the microstructure of the sample on the colloidal length scale. SAXS systems are often used to provide structural information concerning size, shape, internal structure, and mass of particles, particle size distribution in dispersed systems, and even fractal dimensions in disordered systems.

In a SAXS system, the distance between the sample and the x-ray detector is typically much longer than that used in a WAXS system. Due to the small angular deviation from the x-ray beam that occurs in a SAXS system, it is necessary to have this additional length between the sample and detector in order to allow adequate resolution of the captured x-rays. However, the longer distance also increases the noise factor of the system because the scattered x-rays have an increased opportunity to interact with ambient gas molecules. In order to reduce the ambient gas density, SAXS systems typically use an evacuated beam path between the sample and the detector.

### SUMMARY

A detector system for capturing and resolving an incident x-ray beam is provided along with a device for determining structural information of a material incorporating said detector system and a method for examining the structure of a material using said detector system. The detector system generally comprises a sample capable of interacting with the incident x-ray beam, a primary detector and a secondary detector. Upon interaction with a sample of the material, the incident x-ray beam is scattered into wide angle x-ray scattering (WAXS) beams and small angle x-ray scattering (SAXS) beams. The primary detector captures and resolves the WAXS beams. The primary detector includes a fiber-optically coupled array, the array having an input window and a tapered passageway along its central axis to allow the passage of the SAXS beams. The tapered passageway may be conical in shape in order to minimize the loss of imaging area on the primary detector. The secondary detector is placed at a greater distance from the sample than the primary detector and is capable of capturing and resolving the SAXS beams. The tapered passageway is sealed within an enclosure to form an evacuated chamber under vacuum within the detection system through which the SAX beams pass. Optionally, the detector system may further include an output window located in the path of the SAXS beams prior to the secondary detector.

According to another aspect of the present disclosure, a device for determining structural information of a material is provided in which the device comprises an x-ray source capable of providing an incident x-ray beam; a sample positioned to interact with the incident x-ray beam and form wide angle x-ray scattering (WAXS) beams and small angle x-ray scattering (SAXS) beams; and the detector system described herein that is capable of capturing and resolving both WAXS and SAXS beams

According to yet another aspect of the present disclosure, a method for examining the structure of a material is provided. This method generally comprises the steps of irradiating a sample of the material with an incident x-ray beam, thereby, causing the incident x-ray beam to be scattered into wide angle x-ray scattering (WAXS) beams and small angle x-ray scattering (SAXS) beams; capturing and resolving the WAXS beams with a primary detector; passing the SAXS beams through the input window into the tapered passageway; allowing the SAXS beams to pass through the evacuated chamber; and capturing and resolving the SAXS beams with a secondary detector. Optionally, the method may further include passing the SAXS beams through an output window located in the path of the SAXS beams prior to the secondary detector. The secondary detector is located at a greater distance from the sample than the primary detector.

The primary detector includes a fiber-optically coupled array that has an window and a tapered passageway along its central axis. The tapered passageway is sealed within an enclosure, thereby, forming an evacuated chamber having a vacuum environment. The primary detector may be comprised of a phosphor screen capable of converting x-rays to visible light and a charge coupled device (CCD) capable of imaging the light emitted by the phosphor. The tapered passageway through which the SAXS beams pass may be conical in shape in order to minimize the loss of imaging area on the primary detector.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is cross-sectional view of a fiber-optically coupled detector array system with a sealed cavity for passage of x-rays diffracted at small angles constructed according to the teachings of the present disclosure; and

FIG. 2 is a schematic representation of a method for examining the structure of a material according to the teachings of the present disclosure.

### DETAILED DESCRIPTION

The following description is merely exemplary in nature and is in no way intended to limit the present disclosure or its application or uses. It should be understood that throughout the description and drawings, corresponding reference names or numerals indicate like or corresponding parts and features.

The present disclosure generally provides a detector system composed of a fiber-optically coupled detector array in which the hole along the axis of the array is sealed to form an enclosed cavity within the detector. The cavity is maintained under vacuum by the use of input and output windows that have a low absorption for x-rays and which are appropriately sealed to an outer chamber. The detector system allows for capture and resolving of the wide angle x-ray scattering (WAXS) beams and allows passage of the small angle x-ray scattering (SAXS) beams with reduced absorption of the SAXS beams by providing a vacuum cavity for their passage. The invention therefore enables both simultaneous collection of WAXS and SAXS data with reduced attenuation of the SAXS beam thereby improving data quality.

X-ray diffraction is a technique used to determine the molecular structures of materials. One type of detector used in x-ray diffraction is the fiber-optically coupled CCD imaging detector. This type of detector consists of a phosphor screen to convert x-rays to visible light and a CCD (charge-coupled device) that images the light emitted by the phosphor. Efficient transfer of the light from the phosphor to the CCD is accomplished through the use of a fiber-optic bundle. To enlarge the area that can be viewed by the CCD, a fiber-optic taper can be used. For very large imaging areas, a detector system composed of an array of fiber-optically coupled CCDs is constructed. To reduce noise in CCD detectors and improve image quality, some method of cooling the CCD to a temperature below ambient is used. Since cooling is facilitated under vacuum conditions, the fiber-optic bundle and CCD are usually sealed into a vacuum chamber with the input face of the fiber-optic bundle extending outside of the chamber.

Depending on the material being analyzed and the energy of the x-rays used, x-rays may be scattered over a broad range of angles. Different information about the substance under inspection may be inferred from the use of wide angle x-ray scattering (WAXS) and the small angle x-ray scattering (SAXS). Detectors are generally designed to collect either WAXS or SAXS data. To efficiently capture and resolve x-rays scattered at wide angles but allow the collection of small angle scattering by a secondary detector, a fiber optic taper array with a hole along its central axis can be employed. This configuration allows SAXS beams to pass through a primary detector which captures the WAXS beams. A secondary detector is placed at a larger distance from the sample which allows for efficient resolving of the SAXS beams. The hole in the primary detector may be tapered or conical to minimize loss of imaging area on this detector and to avoid overly interfering with the small angle scattered beams. For some of the x-ray energies used, the longer distance traversed by the SAXS beams can result in significant loss of signal due to absorption and scattering by air.

The following specific embodiments are given to illustrate the design and use of camera according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

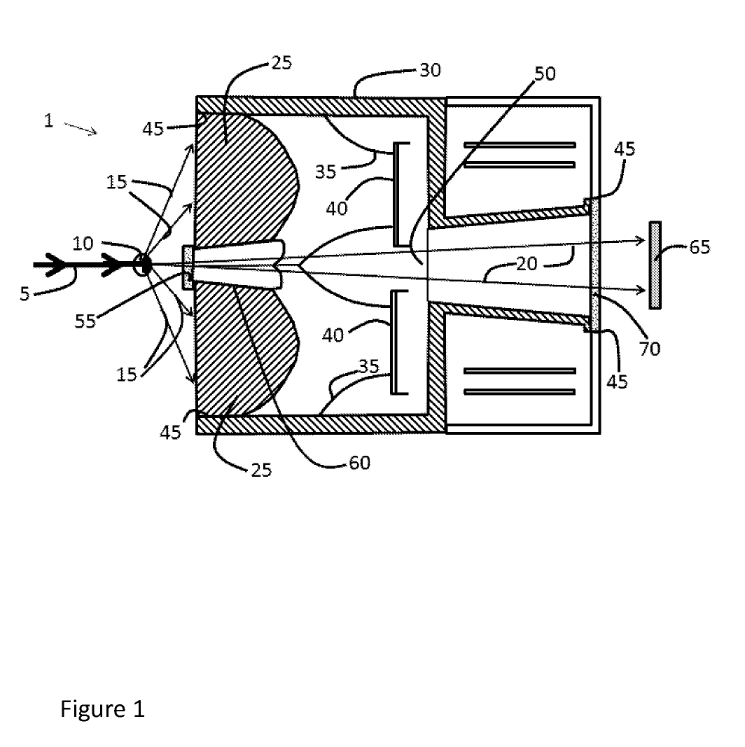

The present disclosure combines both measuring capabilities for WAXS and SAXS beams into a single detection system. In FIG. 1, a configuration of the detector system 1 prepared according to one aspect of the present disclosure is provided. In this system 1, an incident x-ray beam 5 interacts with a sample 10 and is scattered or diffracted into both wide angle x-ray scattering (WAXS) 15 and small angle x-ray scattering (SAXS) 20 beams. WAXS 15 beams are captured and resolved using a fiber-optically coupled array 25 located in an enclosure 30. The fiber-optically coupled array 25 includes a tapered surface 35 that collimates the WAXS 15 beams with at least one primary detector 40.

As shown, the enclosure 30 includes a plurality of vacuum seals 45, thereby, allowing for the formation of an evacuated chamber 50 within the enclosure. The SAXS beams 20 pass through an input window 55 in the vacuum sealed enclosure 30 and are directed through an angular cone or tapered passageway 60 created in the fiber-optically coupled array 25 used to capture and resolve the WAXS beams 15. The SAXS beams 20 ultimately are captured and resolved by a secondary detector 65 that is either external to the detector system 1 or in contact therewith. Alternatively, the secondary detector 65 may be positioned such that the detector system does not require an output window 70. The secondary detector 65 used in capturing and resolving the SAXS beams 20 may be the same type or a different type of detector than the primary detector 40 used to capture and resolve the WAXS beams 15.

The tapered passageway 60 is defined to have a conical hole located and along a central axis through the fiber-optically coupled array 25. The tapered passageway 60 is conical in shape in order to minimize the loss of imaging area on the primary detector 40 for resolution of the WAXS beams 15. This tapered passageway 60 allows the SAXS beams 20 to be directed through an output window 70 located on the side of the enclosure 30 that is opposite the input window 55. The angular cone or tapered passageway 60 is located within a vacuum chamber 50 established in the sealed enclosure 30. The length of the vacuum chamber 50 is predetermined to provide the desired level of resolution of the SAXS beams 20. The vacuum environment in the evacuated chamber 50 reduces any loss of signal due to absorption and/or scattering that would result between the SAXS beams 20 and gas molecules present in the air or atmosphere.

The incident x-rays 5 are electromagnetic radiation with typical photon energies in the range of about 100 eV to about 100 keV. The wavelength of the incident x-rays 5 may be short to long wavelength having a range of about 0.1 angstrom to a few angstroms, alternatively up to about 3 angstroms. Since the wavelength of incident x-rays are comparable to the size of atoms, they are ideally suited for use in probing the surface and bulk structural arrangement of atoms and molecules in a wide range of materials.

The incident x-rays 5 may be produced by any means known to one skilled in the art of radiology. Such a means includes, but is not limited to, the use of x-ray tubes, synchrotron radiation, rotating anode generator, or a cobalt 60 gun, among others. In an x-ray tube, for example, x-rays are generated when a focused electron beam accelerated across a high voltage field bombards a stationary or rotating solid target. As the electrons collide with the atoms present in the target, a continuous spectrum of x-rays is emitted. Several specific examples of targets used in x-ray tubes include Cu and Mo, which emits 8 keV and 14 keV x-rays with corresponding wavelengths of 1.54 Å and 0.8 Å, respectively. According to another aspect of the present disclosure, the x-ray source may include a filter-monochromator, which selectively reflects the intense characteristic radiation of the target material.

The input 55 and output 70 windows are independently selected and exhibit low or minimal absorption of x-rays. The windows may be selected from any known material with low x-ray absorption, such as beryllium, diamond or other forms of carbon, polymeric materials, and mixtures or combinations thereof. Suitable materials for the windows would typically be composed of low atomic number elements because of their low x-ray absorption. The windows may be comprised of a single bulk layer of material or constructed from the deposition, sputtering, coating, or casting of multiple thin layers to form a multi-layered composite structure.

The primary 40 and secondary 65 detectors are independently selected and may include any known design. Several examples of such detectors include photofilms, photodiode x-ray counter, and large area amorphous silicon or selenium detectors, as well as a phosphor screen to convert x-rays to visible light and a charge coupled device (CCD) or array to image the light emitted by the phosphor. The detectors may be of variable geometry such that the angle of scattered radiation that they are able to detect can be changed or adjusted for different applications and/or when desired. The angular position of the detector may be controlled through the use of a high precision micro-actuator or the like.

The enclosure 30 that encompasses the detector system 1 may be manufactured of any material capable of withstanding the forces attributed to the application of a vacuum necessary to form the evacuation chamber 50 within the enclosure 30. The evacuation chamber 50 may be evacuated to any vacuum level necessary to achieve the desired level of noise and resolution of the x-rays captured by the secondary detector 65 in a given or predetermined application. The vacuum level does not have to be extremely high for use in many applications. A vacuum level of 0.4 mbar will reduce the air density in the evacuation chamber 50 by more than 2500 times as compared to atmospheric pressure of 1 atmosphere.

The sample whose structure may be probed and analyzed using the x-ray detector system of the present disclosure includes any solid, liquid, or vapor in any desirable shape or consistency. For example, the solid samples used in conjunction with the detector system may include, but not be limited to, thin films or powders. The detector system of the present disclosure may also be utilized in multiple different industrial applications, such as medical & biological, R&D, security, catalysis, electronic and optical materials, and plastic product design and manufacturing, to name a few.

According to another aspect of the present disclosure, a device is provided that is capable of determining structural information of a desired material. This device generally comprises an x-ray source capable of providing an incident x-ray beam, a sample, and a detector system. The sample is positioned such that it interacts with the incident x-ray beam to form both wide angle x-ray scattering (WAXS) beams and small angle x-ray scattering (SAXS) beams. The detector system is chosen to capture and resolve both the WAXS and SAXS beams. The detector system comprises an enclosure; a primary detector, and a secondary detector as previously described herein. More specifically, the primary detector captures and resolves the WAXS beams, while the secondary detector captures and resolves the SAXS beams. The primary detector includes a fiber-optically coupled array having an input window and a tapered passageway along its central axis to allow the passage of the SAXS beams. The secondary detector is placed at a greater distance from the sample than the primary detector. The tapered passageway is sealed within the enclosure to form an evacuated chamber within the detection system through which the SAX beams pass, e.g., the evacuated chamber is placed under a vacuum. The evacuated chamber reduces the presence of air or other gaseous molecules that may interact with the SAXS beams, thereby, creating noise and reducing the resolution associated with the captured SAXS beams.

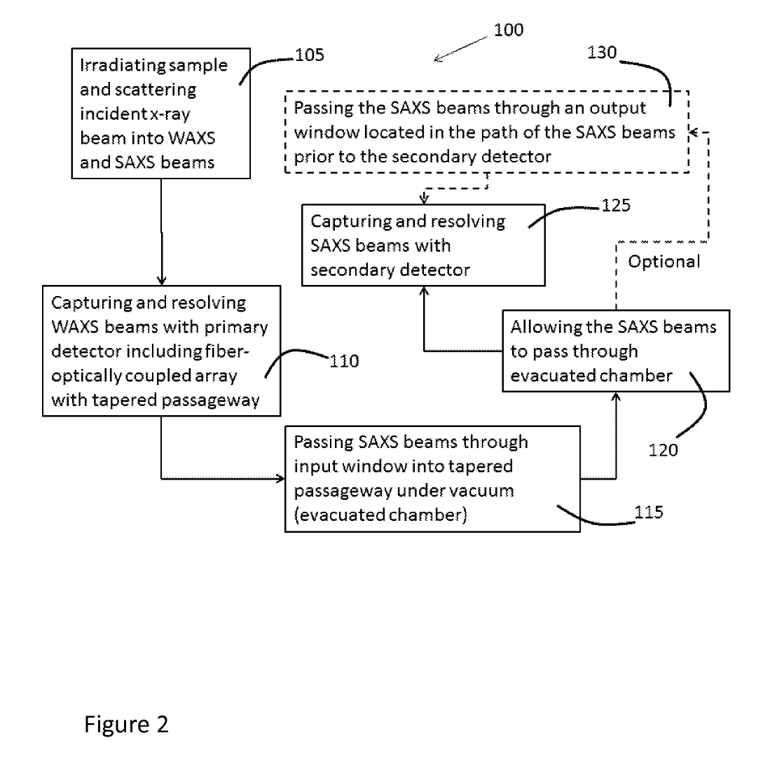

According to yet another aspect of the present disclosure, a method for examining the structure of a material is provided. Referring now to FIG. 2, the method 100 comprises irradiating a sample 105 of the material with an incident x-ray beam. Upon interaction with the sample, the incident x-ray beam is scattered into wide angle x-ray scattering (WAXS) beams and small angle x-ray scattering (SAXS) beams. The WAXS beams are then captured and resolved 110 with a primary detector, which includes a fiber-optically coupled array having a window and a tapered passageway along its central axis. The primary detector may be comprised of a phosphor screen capable of converting x-rays to visible light and a charge coupled device (CCD) capable of imaging the light emitted by the phosphor.

The SAXS beams are allowed to pass 115 through the input window of the primary detector into the tapered passageway. The tapered passageway is sealed within an enclosure, thereby, forming an evacuated chamber within the enclosure that is subjected to a vacuum environment. This tapered passageway is conical in shape in order to minimize the loss of imaging area on the primary detector. The SAXS beams are then allowed to pass 120 through the evacuated chamber; and are subsequently captured and resolved 125 by a secondary detector. The secondary detector is located at a greater distance from the sample than the primary detector. Optionally, the method may further comprise passing 130 the SAXS beams through an output window that is located in the path of the SAXS beams prior to the secondary detector. The SAXS beams are allowed to pass through the input and output windows because these windows have a low absorption for x-rays.

The foregoing description of various embodiments of the invention has been presented for purposes of illustration and description. It is not intended to be exhaustive or to limit the invention to the precise embodiments disclosed. Numerous modifications or variations are possible in light of the above teachings. For example, the detector system of the present disclosure may be used with various peripheral equipment normally used in a diffractometer or similar devices including, but not limited to, filters, mirrors, collimators, beamstops, pinholes or slits, translation stages, microscopes, and video cameras.

The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A detector system for capturing and resolving an incident x-ray beam, the system comprising:
a sample capable of interacting with the incident x-ray beam to form wide angle x-ray scattering (WAXS) beams and small angle x-ray scattering (SAXS) beams;
a primary detector for capturing and resolving the WAXS beams, the primary detector including a fiber-optically coupled array, the array having an input window and a tapered passageway along its central axis to allow the passage of the SAXS beams,
a primary detector for capturing and resolving the WAXS beams; and
a secondary detector placed at a greater distance from the sample than the primary detector; the secondary detector capable of capturing and resolving the SAXS beams;
wherein the tapered passageway is sealed within an enclosure to form an evacuated chamber within the detection system through which the SAX beams pass;
the evacuated chamber capable of being placed under a vacuum.

2. The detector system of claim 1, wherein the tapered passageway is conical in shape in order to minimize the loss of imaging area on the primary detector.

3. The detector system of claim 1, wherein the detector system further includes an output window, the output window located in the path of the SAXS beams prior to the secondary detector.

4. The detector system of claim 3, wherein the input and output windows have a low absorption for x-rays.

5. The detector system of claim 1, wherein the primary detector includes a phosphor screen to convert x-rays to visible light and a charge coupled device (CCD) to image the light emitted by the phosphor.

6. A device for determining structural information of a material, the device comprising:
an x-ray source capable of providing an incident x-ray beam;
a sample, the sample positioned to interact with the incident x-ray beam to form wide angle x-ray scattering (WAXS) beams and small angle x-ray scattering (SAXS) beams;
a detector system capable of capturing and resolving the WAXS and SAXS beams; the detector system comprising:
an enclosure;
a primary detector for capturing and resolving the WAXS beams, the primary detector including a fiber-optically coupled array, the array having an input window and a tapered passageway along its central axis to allow the passage of the SAXS beams,
a primary detector for capturing and resolving the WAXS beams; and
a secondary detector placed at a greater distance from the sample than the primary detector; the secondary detector capable of capturing and resolving the SAXS beams;
wherein the tapered passageway is sealed within the enclosure to form an evacuated chamber within the detection system through which the SAX beams pass; the evacuated chamber capable of being placed under a vacuum.

7. The device of claim 6, wherein the tapered passageway in the detector system is conical in shape in order to minimize the loss of imaging area on the primary detector.

8. The device of claim 6, wherein the detector system further includes an output window, the output window located in the path of the SAXS beams prior to the secondary detector.

9. The device of claim 8, wherein the input and output windows of the detector system have a low absorption for x-rays.

10. The device of claim 6, wherein the primary detector of the detector system includes a phosphor screen to convert x-rays to visible light and a charge coupled device (CCD) to image the light emitted by the phosphor.

11. A method for examining the structure of a material; the method comprising:
irradiating a sample of the material with an incident x-ray beam; wherein upon interaction with the sample, the incident x-ray beam is scattered into wide angle x-ray scattering (WAXS) beams and small angle x-ray scattering (SAXS) beams;
capturing and resolving the WAXS beams with a primary detector; the primary detector including a fiber-optically coupled array having a window and a tapered passageway along its central axis;
passing the SAXS beams through the input window into the tapered passageway; the tapered passageway being sealed within an enclosure, thereby, forming an evacuated chamber; the evacuated chamber having a vacuum environment;
allowing the SAXS beams pass through the evacuated chamber; and
capturing and resolving the SAXS beams with a secondary detector; the secondary detector being located at a greater distance from the sample than the primary detector.

12. The method of claim 11, wherein the tapered passageway through which the SAXS beams pass is conical in shape in order to minimize the loss of imaging area on the primary detector.

13. The method of claim 11, wherein the method further includes passing the SAXS beams through an output window; the output window being located in the path of the SAXS beams prior to the secondary detector.

14. The method of claim 13, wherein the SAXS beams are passed through input and output windows that have a low absorption for x-rays.

15. The method of claim 11, wherein the WAXS beams are captured and resolved using a primary detector comprised of a phosphor screen capable of converting x-rays to visible light and a charge coupled device (CCD) capable of imaging the light emitted by the phosphor.
